(19) United States
(12) Patent Application Publication
(10) Pub. No.: US 2012/0015642 A1
(43) Pub. Date: Jan. 19, 2012

(54) FIRMWARE UPDATE METHOD FOR MOBILE TERMINAL AND MOBILE TERMINAL USING THE SAME

(76) Inventor: Sang Uk Seo, Metropolitan City (KR)

(21) Appl. No.: 13/242,910

(22) Filed: Sep. 23, 2011

Related U.S. Application Data
(63) Continuation of application No. 11/715,960, filed on Mar. 9, 2007.

(30) Foreign Application Priority Data
Sep. 7, 2006 (KR) 2006-86362

(51) Int. Cl. H04M 3/00

(52) U.S. Cl. 455/419

(57) ABSTRACT

A method for updating a firmware of a mobile terminal over the air in a mobile communication system and a mobile terminal using the same are provided comprising an internal memory and a detachable external memory and downloading an update file of a firmware from a firmware server over the air, in which size information of the update file is received, a download storage for storing the update file is selected in accordance with the size information, the update file is downloaded and stored in the selected download storage, and the firmware is updated with the stored update file. Accordingly, an update file can be selectively stored in an internal memory and an external memory in accordance with available storage capability using a firmware over-the air (FOTA) function.

### CROSS-REFERENCE TO RELATED PATENT APPLICATION

This application is a continuation of U.S. patent application bearing Ser. No. 11/715,960, filed on Mar. 9, 2007, which claims the benefit under 35 U.S.C. §119(a) of Korean Patent Application filed in the Korean Intellectual Property Office on Sep. 7, 2006 bearing Serial No. 2006-86362, the entire disclosures of which are hereby incorporated by reference.

### BACKGROUND OF THE INVENTION

1. Field of the Invention

The present invention relates to a mobile communication system. More particularly, the present invention relates to a method for updating a firmware of a mobile terminal over the air in a mobile communication system.

2. Description of the Related Art

Firmware over-the-air (FOTA) is a new solution that enables a mobile terminal to download and install updated software over the air. The software includes patches, updated versions of the software, and operation system. The FOTA is a technique for managing the update of mobile terminals such as cell phones, wireless personal digital assistants (PDAs), laptop computers, and the like, as well as fixed wireless terminals. The FOTA enables a user to avoid a burden of visiting a customer care center for updating firmware or application programs of the mobile terminal. FOTA, which focused on fixing bugs in early versions, has been widely adopted as an integral software management technology for upgrading various application programs, as the mobile terminals become more complex with various functions.

In developing FOTA update technologies, three key criteria should be considered: a client software that is installed in a mobile terminal for downloading and updating a software package from a server; a component distributor that creates a software update package in accordance with the difference between an old version and a new version in units of byte by means of a differential algorithm; and the server that controls the update of the mobile terminals.

Typically, a new version of the firmware is downloaded over the air channel and stored into an inbuilt memory of the mobile terminal for replacing an old version of the firmware.

In another case, the new version of the firmware is downloaded by a personal computer through the Internet and then the downloaded new version of the firmware is moved to the mobile terminal using an external memory device.

However, the conventional mobile terminal described above is limited in memory capacity and central processing unit (CPU) performance, such that it is difficult to perform a firmware update when an update file is large or frequent updates are required. Even when the size of the file to be downloaded is not so large, unstable air channel and low CPU performance may cause downloading errors.

Recent advances in CPU performance and wireless communication technology satisfy some conditions for downloading large files over the air. However, most conventional firmware update methods do not keep pace with such an advanced communication environment.

Accordingly, there is a need for an improved firmware update method for a mobile terminal and mobile terminal using the same

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a firmware update method for a mobile terminal that is capable of downloading update files regardless of a limited storage capacity of the mobile terminal and a mobile terminal implementing the same.

It is another aspect of exemplary embodiments of the present invention to provide a firmware update method for a mobile terminal that is capable of securing stable downloading of a firmware even with frequent downloads of update files and a mobile terminal implementing the same.

In accordance with an aspect of exemplary embodiments of the present invention, the above and other objects are accomplished by a firmware update method for a mobile terminal having an internal memory and a detachable external memory and downloading an update file of a firmware from a firmware server over the air. The firmware update method includes receiving size information of the update file, selecting a download storage for storing the update file in accordance with the size information, downloading and storing the update file in the selected download storage and updating the firmware with the stored update file.

In an exemplary implementation, selecting a download storage includes determining whether an available capacity of the internal memory is enough for storing the update file, determining, if an available capacity of the internal memory is not enough for storing the update file, whether the external memory is attached, determining, if the external memory is attached, whether an available capacity of the external memory is enough for storing the update file, and selecting, if an available capacity of the external memory is enough for storing the update file, the external memory as the download storage.

In another exemplary implementation, selecting a download storage further includes transmitting, if an available capacity of the external memory is not enough for storing the update file, an update failure message to the firmware server.

In still another exemplary implementation, selecting a download storage further includes outputting, if an available capacity of the external memory is not enough for storing the update file, an announcement message notifying an update failure.

In a further exemplary implementation, the external memory is a memory card.

In an exemplary implementation, the size information is received in the form of a descriptor.

In accordance with another aspect of exemplary embodiments of the present invention, the above and other objects are accomplished by a firmware update method for a mobile terminal having an internal memory and a detachable external memory and downloading an update file of a firmware from a firmware server over the air. The firmware update method includes receiving size information of the update file from the firmware server, selecting a download storage for storing the update file in accordance with the size information; requesting the update file to the firmware server, receiving the update file from the firmware server, storing the update file in the selected download storage; and updating the firmware with the stored update file.

In an exemplary implementation, receiving size information includes requesting the size information to the firmware server.

In another exemplary implementation, selecting a download storage includes determining whether an available capacity of the internal memory is enough for storing the update file; determining, if an available capacity of the internal memory is not enough for storing the update file, whether the external memory is attached, determining, if the external memory is attached, whether an available capacity of the external memory is enough for storing the update file, and selecting, if an available capacity of the external memory is enough for storing the update file, the external memory as the download storage.

In still another exemplary implementation, selecting a download storage further includes transmitting, if an available capacity of the external memory is not enough for storing the update file, an update failure message to the firmware server.

In a further exemplary implementation, selecting a download storage further includes outputting, if an available capacity of the external memory is not enough for storing the update file, an announcement message notifying an update failure.

In an exemplary implementation, the external memory is a memory card.

In another exemplary implementation, the update file is a batch file for executing the update file of the firmware.

In still another exemplary implementation, the size information is received in the form of a descriptor.

### BRIEF DESCRIPTION OF THE DRAWINGS

The above and other objects, features and advantages of certain exemplary embodiments of the present invention will be more apparent from the following detailed description in conjunction with the accompanying drawings, in which:

FIG. 1 is a block diagram illustrating a configuration of a mobile terminal adopting a firmware update method according to an exemplary embodiment of the present invention;

FIG. 2 is a block diagram illustrating a configuration of a mobile communication system adopting a firmware update method according to an exemplary embodiment of the present invention;

FIG. 3 is a message flow diagram illustrating interoperation of network elements of FIG. 2 in a firmware update method according to an exemplary embodiment of the present invention; and

FIG. 4 is a flowchart illustrating a firmware update method according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

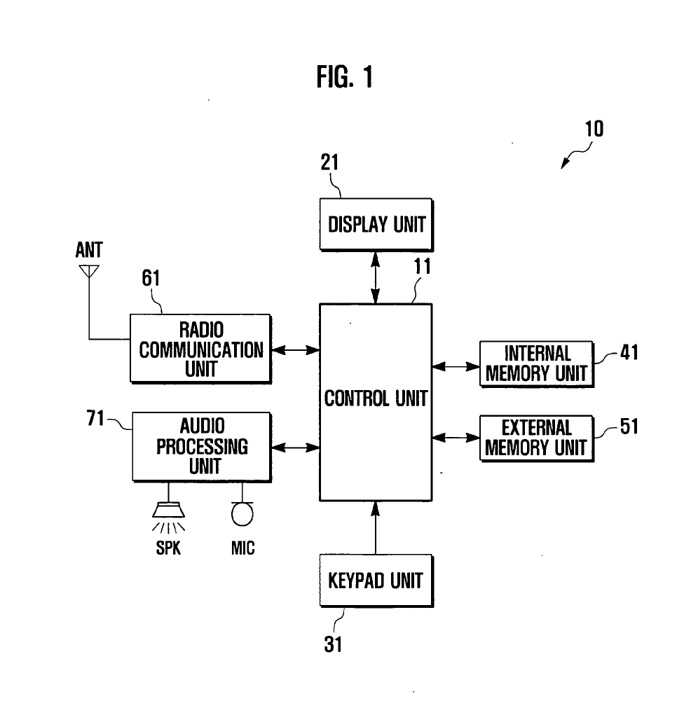

FIG. 1 is a block diagram illustrating a configuration of a mobile terminal adopting a firmware update method according to an exemplary embodiment of the present invention.

Referring to FIG. 1, the mobile terminal 10 includes a control unit 11, display unit 21, keypad unit 31, internal memory unit 41, external memory unit 51, radio communication unit 61 and audio processing unit 71.

The control unit 11 controls overall operations of the mobile terminal 10 including voice and data communications, wireless Internet access, and audio and data signal processes according to inbuilt protocols. The control unit 11 controls download update files of its firmware from a firmware server (not shown) using a FOTA function and to selectively store the downloaded update files in the internal memory unit 41 and the external memory unit 51. The control unit 11 executes the downloaded update files to update the firmware. The control unit 11 also can request a specific function-related firmware to the firmware server. The control unit 11 also processes a firmware update request message transmitted from the firmware server.

The internal memory unit 41 stores execution instructions associated with keys provided on the keypad unit 31 and information input by a user or received from outside through the radio communication unit 61. The external memory unit 51 is a storage device for compensating a capacity limit of the internal memory unit 41. The external memory unit 51 is likely to be used for storing relatively large files such as MP3 and motion pictures.

The keypad 31 is provided with a plurality of alphanumeric and function keys and transfers data input by key manipulation to the control unit 11.

The audio processing unit 71 processes and replays audio signals, modulates voice signals input through a microphone (MIC) into voice data to transmit through the radio communication unit 61, and demodulates voice data received through the radio communication unit 61 to output through a speaker (SPK).

The radio communication unit 61 separates radio signals transmitted and received through an antenna (ANT). The radio communication unit 61 up-converts data signals from the control unit 11 into radio signals and transmits the radio signals through the antenna. The radio communication unit 61 also down-converts radio signals received through the antenna into data signals and transfers the data signals to the control unit 11. The radio communication unit 61 also processes an update file request message for requesting a firmware required for a specific function of the mobile to the firmware server, and processes the update files received from the firmware server in response to the update file request message under the control of the control unit 11.

The display unit 21 presents various menu screen images, user input data images, and various application data images.

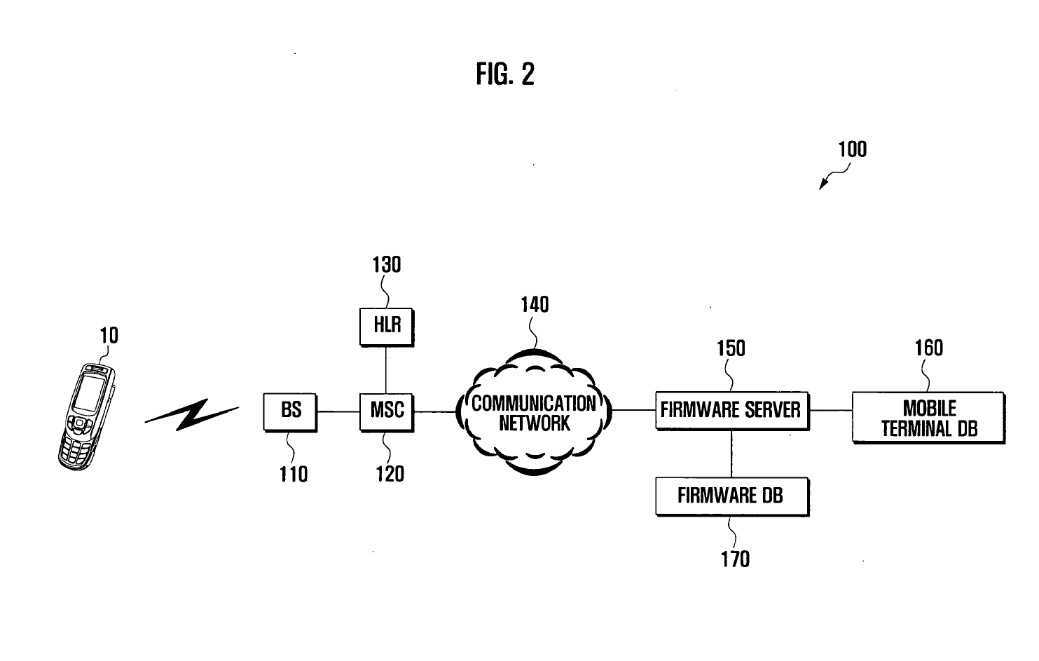

FIG. 2 is a block diagram illustrating a configuration of a mobile communication system adopting a firmware update method according to an exemplary embodiment of the present invention.

Referring to FIG. 2, the mobile communication system 100 includes a mobile terminal 10, base station (BS) 110, mobile switching center (MSC) 120, home location register (HLR) 130, communication network 140, firmware server 150, mobile terminal database (DB) 160, and firmware database (DB) 170.

The BS 110 provides a radio access service to the mobile terminal 10, bridges a wireless network and a wired network, and supports a handover of the mobile terminal 10. The MSC 120 interoperates with other MSCs for processing transmitted and received calls for the mobile terminal 10, and refers to the HLR 130 for subscriber information. The HLR 130 is a database equipment for managing information on the mobile terminal subscribers. The HLR 130 stores mobile terminal subscriber information and mobility information, and can assign a path of an incoming call. The communication network 140 bridges the mobile terminal 10 and the firmware server 150. The mobile terminal DB 160 manages information on firmware programs contained in the mobile terminal 10. The firmware server 150 refers to the mobile terminal DB 160 for information on a version of the firmware. The firmware DB 170 provides the firmware server 150 with the firmware or an update file of the firmware.

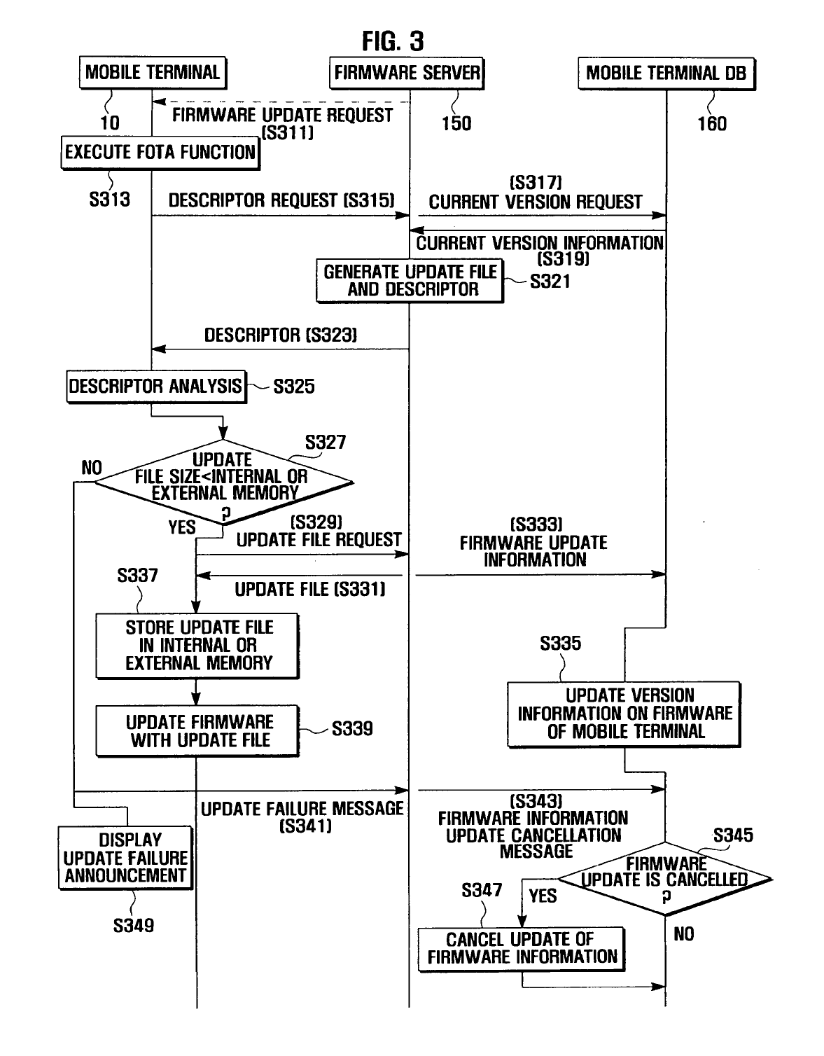

FIG. 3 is a message flow diagram illustrating interoperation of network elements of FIG. 2 in a firmware update method according to an exemplary embodiment of the present invention.

Referring to FIGS. 2 and 3, the firmware server 150 checks a version of a firmware of the mobile terminal 10 and transmits a firmware update request message (S311) if the firmware of the mobile terminal is not the most recent version. The version information is managed by the mobile terminal DB 160 operated in association with the firmware server 150. The firmware update can be triggered by the mobile terminal 10, in which the firmware update request message is transmitted from the mobile terminal 10 to the firmware server 150.

Upon receiving the firmware update request message, the mobile terminal 10 executes an FOTA function to establish a connection with the firmware server 150 (S313). After the connection is established, the mobile terminal 10 transmits a descriptor request message to the firmware server 150 for receiving a descriptor of an update file of the firmware (S315).

The firmware server 150 then transmits a current version request message to the mobile terminal DB 160 for verifying the current version of the firmware of the mobile terminal (S317). In response to the current version request message, the mobile terminal DB 160 transmits information on the current version of the mobile terminal 10 to the firmware server 110 (S319). Upon receiving the current version information of the mobile terminal, the firmware server 150 generates an update file of the firmware and a descriptor in accordance with a difference between the current version and the most recent version (S321). The descriptor contains information on the update file of the firmware. Next, the firmware server 150 transmits the descriptor to the mobile terminal 10 (S323).

The mobile terminal 10 analyzes the descriptor to check a capacity required for storing the update file (S325) and then determines whether an available capacity of the internal memory or of the external memory is greater than a size of the update file (S327). If the available capacity of at least one of the memories is enough to store the update file, the mobile terminal 10 transmits an update file request message to the firmware server 150 (S329). In response to the update file request message, the firmware server 150 transmits the update file to the mobile terminal 10 (S331) and simultaneously transmits firmware update information about the mobile terminal 10 to the mobile terminal DB 160 (S333). The mobile terminal DB 160 updates the version information of the mobile terminal in accordance with the firmware update information (S335). While receiving the update file, the mobile terminal 10 stores the update file in one of the internal and external memories (S337).

When the download is completed, the mobile terminal 10 executes a firmware update process (S339). The update file can be a batch file for executing the firmware update.

If the available capacity for both of the internal memory and the external memory is not enough for storing the update file, the mobile terminal 10 transmits an update failure message to the firmware server 150 (S341). In this case, the mobile, for example, displays an announcement message notifying that the update file download has failed (S349).

Upon receiving the update failure message, the firmware server 150 transmits a firmware information update cancellation message to the mobile terminal DB 160 (S343). The mobile terminal DB 160 analyzes the firmware information update cancellation message and determines whether the firmware update is canceled (S345). If it is determined that the firmware update is canceled, the mobile terminal DB cancels the update of the version information of the firmware of the mobile terminal 10 (S347).

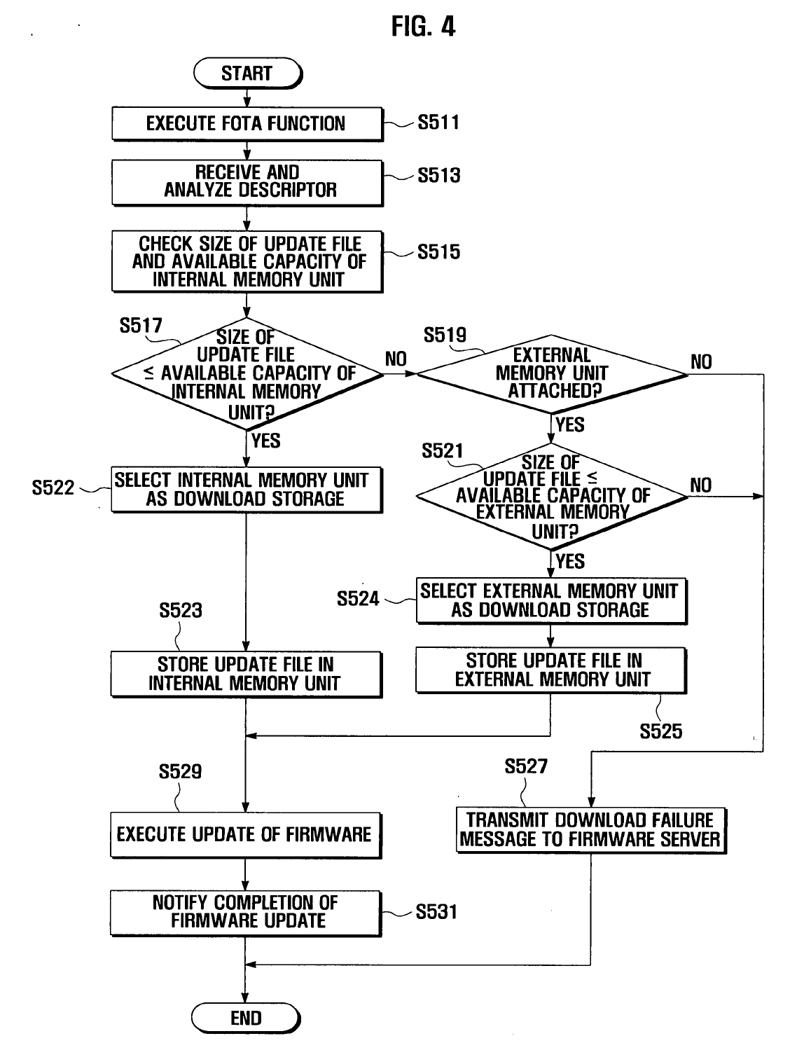

FIG. 4 is a flowchart illustrating a firmware update method according to an exemplary embodiment of the present invention.

Referring to FIGS. 1 to 4, the control unit 11 of the mobile terminal 10 activates an FOTA function for updating its firmware (S511). The firmware update can be triggered by a firmware server, a currently associated BS, or a user's key manipulation. The control unit 11 establishes a connection to the firmware server 150, receives a descriptor of an update file of the firmware, and analyzes the descriptor of the update file (S513). Next, the control unit 11 verifies a size of the update file in accordance with the descriptor and an available capacity of the internal memory unit 41 (S515).

The control unit 11 compares the available capacity of the internal memory unit 41 and the size of the update file, and determines whether the available capacity of the internal memory unit 41 is enough for storing the update file (S517). If it is determined that the available capacity of the internal memory unit 41 is enough for storing the update file, the control unit 11 selects the internal memory unit 41 as a download storage (S522) and stores the update file in the internal memory unit 41 while downloading (S523).

If it is determined that the available capacity of the internal memory unit 41 is not enough for storing the update file, the control unit 11 determines whether the external memory unit 51 is attached to the mobile terminal 10 (S519). If the external memory unit 51 is attached to the mobile terminal 10, the control unit 11 compares an available capacity of the external memory unit 51 and the size of the update file and determines whether the available capacity of the external memory unit 51 is enough for storing the update file (S521). If it is determined that the available capacity of the external memory unit 51 is enough for storing the update file, the control unit 11 selects the external memory unit 51 as the download storage (S524) and stores the update file in the external memory unit 51 while downloading (S525).

After storing the update file in the internal memory unit 41 or the external memory unit 51, the control unit 11 executes the update file (S529) to process the update of the firmware. When the firmware update is complete, the control unit 11 notifies the completion of the firmware update through the display unit 21 or the audio processing unit 71 (S531).

If it is determined that the external memory unit 51 is not attached to the mobile terminal 10 at step S519, or that the available capacity of the external memory unit 51 is not enough for storing the update file at step S521, the control unit 11 outputs an announcement message notifying that the update file download has failed though the display unit 21 and transmits the download failure message to the firmware server 150 (S527).

As described above, the firmware update method for a mobile terminal according to exemplary embodiments of the present invention is allows an update file to be selectively stored in an internal memory and an external memory in accordance with available storage capability using an FOTA function.

Also, the firmware update method of exemplary embodiments of the present invention can improve download stability by avoiding a risk of download failure during a download procedure by determining whether to download the update file in accordance with the available storage capacity before starting the download.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A firmware update method for a mobile device comprising an internal memory and a detachable external memory, the method comprising:
receiving size information of an update file from a firmware server;
selecting one of the internal memory or the detachable external memory as a download storage for storing the update file in accordance with the size information;
downloading and storing the update file of a firmware from the firmware server in the selected download storage; and
updating a firmware with the stored update file,
wherein the selecting of the download storage comprises:
determining whether an available capacity of the internal memory is sufficient for storing the update file using the size information of the update file;
if an available capacity of the internal memory is sufficient for storing the update file, selecting the internal memory as the download storage; if an available capacity of the internal memory is not sufficient for storing the update file, determining whether the external memory is attached;
if an external memory is attached, determining whether an available capacity of the external memory is sufficient for storing the update file; and
if an available capacity of the external memory is sufficient for storing the update file, selecting the external memory as the download storage.

2. A firmware update method for an electric device comprising an internal memory and a detachable external memory, the method comprising:
receiving size information of an update file from a firmware server;
selecting one of the internal memory or the detachable external memory as a download storage for storing the update file in accordance with the size information;
downloading and storing the update file of a firmware from the firmware server in the selected download storage; and
updating a firmware with the stored update file,
wherein the selecting of the download storage comprises:
determining whether an available capacity of the internal memory is sufficient for storing the update file using the size information of the update file;
if an available capacity of the internal memory is sufficient for storing the update file, selecting the internal memory as the download storage; if an available capacity of the internal memory is not sufficient for storing the update file, determining whether the external memory is attached;
if an external memory is attached, determining whether an available capacity of the external memory is sufficient for storing the update file; and
if an available capacity of the external memory is sufficient for storing the update file, selecting the external memory as the download storage.

3. The firmware update method of claim 1, wherein the selecting of the download storage further comprises, if an available capacity of the external memory is not sufficient for storing the update file, transmitting an update failure message to a firmware server.

4. The firmware update method of claim 1, wherein the selecting of the download storage further comprises, if an available capacity of the external memory is not sufficient for storing the update file, outputting an announcement message comprising a notification of an update failure.

5. The firmware update method of claim 1, wherein the external memory comprises a memory card.

6. The firmware update method of claim 1, wherein the size information is received in a descriptor.

7. A firmware update method for a mobile device comprising an internal memory and a detachable external memory, the method comprising:
receiving size information of an update file from a firmware server;
selecting one of the internal memory or the detachable external memory as a download storage for storing the update file in accordance with the size information;
requesting the update file to the firmware server;
receiving the update file of a firmware from the firmware server;
storing the update file in the selected download storage; and
updating the firmware with the stored update file, wherein selecting a download storage comprises:
determining whether an available capacity of the internal memory is sufficient for storing the update file using the size information of the update file using the size information of the update file;
if an available capacity of the internal memory is sufficient for storing the update file, selecting the internal memory as the download storage;
if an available capacity of the internal memory is not sufficient for storing the update file, determining whether the external memory is attached;
if an external memory is attached, determining whether an available capacity of the external memory is sufficient for storing the update file; and
if an available capacity of the external memory is sufficient for storing the update file, selecting the external memory as the download storage.

8. A firmware update method for an electric device comprising an internal memory and a detachable external memory, the method comprising:
receiving size information of an update file from a firmware server;
selecting one of the internal memory or the detachable external memory as a download storage for storing the update file in accordance with the size information;
requesting the update file to the firmware server;
receiving the update file of a firmware from the firmware server;
storing the update file in the selected download storage; and
updating the firmware with the stored update file, wherein selecting a download storage comprises:
determining whether an available capacity of the internal memory is sufficient for storing the update file using the size information of the update file using the size information of the update file;
if an available capacity of the internal memory is sufficient for storing the update file, selecting the internal memory as the download storage;
if an available capacity of the internal memory is not sufficient for storing the update file, determining whether the external memory is attached;
if an external memory is attached, determining whether an available capacity of the external memory is sufficient for storing the update file; and
if an available capacity of the external memory is sufficient for storing the update file, selecting the external memory as the download storage.

9. The firmware update method of claim 7, wherein the receiving of the size information comprises requesting the size information from the firmware server.

10. The firmware update method of claim 7, wherein the selecting of the download storage further comprises, if an available capacity of the external memory is not sufficient for storing the update file, transmitting an update failure message to the firmware server.

11. The firmware update method of claim 7, wherein the selecting of the download storage further comprises, if an available capacity of the external memory is not enough for storing the update file, outputting an announcement message comprising a notification of an update failure.

12. The firmware update method of claim 7, wherein the external memory comprises a memory card.

13. The firmware update method of claim 7, wherein the update file comprises a batch file for executing the update of the firmware.

14. The firmware update method of claim 7, wherein the size information is received in a descriptor.

15. The firmware update method of claim 1, wherein the downloading of the update file comprises downloading from the firmware server over the air.

16. The firmware update method of claim 7, wherein the receiving of the update file comprises receiving from the firmware server over the air.

17. an electric device comprising an internal memory and a detachable external memory, the electronic device comprising:
a control unit for controlling operations of the mobile terminal comprising voice and data communications, wireless Internet access, and audio and data signal processes;
a display unit for presenting at least one of a menu screen image, a user input data image, and an application data image;
an input unit for inputting information by a user;
a first memory unit for storing execution instructions associated with keys provided on the keypad unit and information input by a user or received from outside;
a second memory unit for storing data;
wherein the control unit controls for receiving size information of an update file from a firmware server, selecting one of the internal memory or the detachable external memory as a download storage for storing the update file in accordance with the size information, downloading and storing the update file of a firmware from the firmware server in the selected download storage, and updating a firmware with the stored update file.

18. The electronic device of claim 17, wherein the control unit executes the downloaded update files to update a firmware, requests a specific function-related firmware to the firmware server and processes a firmware update request message transmitted from the firmware server.

19. The electronic device of claim 18, wherein the radio communication unit processes an update file request message for requesting a firmware required for a specific function of the mobile terminal to the firmware server, and processes the update files received from the firmware server in response to the update file request message under the control of the control unit.

20. The electronic device of claim 17, wherein at least one of the first and second memory units comprises an external memory.
